(19) United States
(12) Patent Application Publication
(10) Pub. No.: US 2005/0021488 A1
(43) Pub. Date: Jan. 27, 2005

(54) Mining association rules over privacy preserving data

(76) Inventors: Rakesh Agrawal, San Jose, CA (US); Alexandre Evfimievski, Ithaca, NY (US); Ramakrishnan Srikant, San Jose, CA (US)

Correspondence Address: FREDERICK W. GIBB, III;MCGINN & GIBB, PLLC, 2568-A RIVA ROAD, SUITE 304, ANNAPOLIS, MD, 21401, US

(21) Appl. No.: 10/624,069

(22) Filed: Jul. 21, 2003

(51) Int. Cl. G06F 7/00

(52) U.S. Cl. 707/1

(57) ABSTRACT

The following discloses a method of mining association rules from the databases while maintaining privacy of individual transactions within the databases through randomization. The invention randomly drops true items from transactions within a database and randomly inserts false items into the transactions. The invention mines the database for association rules after the dropping and inserting processes, and estimates the support of association rules in the original dataset based on their support in the randomized dataset. The dropping of the true items and the inserting of the false items is carried out to an extent such that the chance of finding a false itemset is sufficiently high relative to the chance of finding a true itemset in the database.

### CROSS-REFERENCE TO RELATED APPLICATION

The present application is related to pending U.S. patent application Ser. No. 09/487,191, filed Jan. 19, 2000 to Agrawal et al., entitled “System and Architecture for Privacy-Preserving Data Mining” having (IBM) Docket No. AM9-99-0226; U.S. patent application Ser. No. 09/487,697 filed Jan. 19, 2000 to Agrawal et al., entitled “Method and System for Building a Naive Bayes Classifier From Privacy-Preserving Data” having (IBM) Docket No. AM9-99-0224; and, U.S. patent Ser. No. 09/487,642 filed Jan. 19, 2000 to Agrawal et al., entitled “Method and System For Reconstructing Original Distributions from Randomized Numeric Data” having (IBM) Docket No. AM9-99-0224. The foregoing applications are assigned to the present assignee, and are all incorporated herein by reference.

### BACKGROUND OF THE INVENTION

1. Field of the Invention

The present invention generally relates to privacy preserving data mining to build accurate data mining models over aggregated data while preserving privacy in individual data records. This invention introduces the problem of mining association rules over transactions where the transaction data has been sufficiently randomized to preserve privacy in individual transactions, and a framework for recovering the support that allows for a class of randomization operators.

2. Description of the Related Art

The explosive progress in networking, storage, and processor technologies is resulting in an unprecedented amount of digitization of information. It is estimated that the amount of information in the world is doubling every 20 months (Office of the Information and Privacy Commissioner, Ontario, “Data Mining: Staking a Claim on Your Privacy,” January 1998). In concert with this dramatic and escalating increase in digital data, concerns about privacy of personal information have emerged globally (The Economist—“The End of Privacy,” May 1999; European Union, Directive on Privacy Protection, October 1998; Office of the Information and Privacy Commissioner, Ontario, “Data Mining: Staking a Claim on Your Privacy”, January 1998”; and “Time”—The Death of Privacy, August 1997).

Privacy issues are further exacerbated now that the internet makes it easy for new data to be automatically collected and added to databases (Business Week, “Privacy on the Net”, March 2000; L. Cranor, J. Reagle, and M. Ackerman, “Beyond Concern: Understanding Net Users' Attitudes About Online Privacy,” Technical Report TR 99.4.3, AT&T Labs-Research, April 1999; L. F. Cranor, Editor, Special Issue on Internet Privacy, Comm, ACM, 42(2), February 1999; A. Westin, E-Commerce and Privacy: “What Net Users Want,” Technical Report, Louis Harris & Associates, June 1998; A. Westin, “Privacy Concerns & Consumer Choice,” Technical Report, Louis Harris & Associates, December 1998; and A. Westin, “Freebies and Privacy: What Net Users Think,” Technical Report, Opinion Research Corporation, July 1999).

The concerns over massive collections of data are naturally extending to analytic tools applied to data. Data mining, with its promise to efficiently discover valuable, non-obvious information from large databases, is particularly vulnerable to misuse (C. Clifton and D. Marks, “Security and Privacy Implications of Data Mining,” In ACM SIGMOD Workshop on Research Issues on Data Mining and Knowledge Discovery, pages 15-19, May 1996; V. Estivill-Castro and L. Brankovic, “Data swapping: Balancing Privacy Against Precision in Mining for Logic Rules,” In M. Mohania and A. Tjoa, Editors, Data Warehousing and Knowledge Discovery DaWaK-99, pages 389-398, Springer-Verlag Lecture Notes in Computer Science 1676, 1999; Office of the Information and Privacy Commissioner, Ontario. Data Mining: Staking a Claim on Your Privacy, January 1998; and K. Thearling, “Data Mining and Privacy: A Conflict in Making,” DS*, March 1998).

An interesting new direction for data mining research is the development of techniques that incorporate privacy concerns (R. Agrawal, “Data Mining: Crossing the Chasm,” In 5^{th} Int'l Conference on Knowledge Discovery in Databases and Data Mining, San Diego, Calif., August 1999, Available from http://www.almaden.ibm.com/cs/quest/papers/kdd99_chasm.ppt”). The following question, “Can we develop accurate models without access to precise information in individual data records?” is raised in “R. Agrawal and R. Srikant, “Privacy Preserving Data Mining,” In Proc. of the ACM SIGMOD Conference on Management of Data, pages 439-450, Dallas, Tex., May 2000”, since the primary task in data mining is the development of models about aggregated data. Specifically, the study of the technical feasibility of building accurate classification models using training data in which the sensitive numeric values in a user's record have been randomized so that the true values cannot be estimated with sufficient precision. Randomization is done using the statistical method of value distortion that returns a value χ+r instead of χ where r is a random value drawn from some distribution (“R. Conway and D. Strip, “Selective Partial Access to a Database,” In Proc. ACM Annual Conf., pages 85-89, 1976). A Bayesian procedure is proposed for correcting perturbed distributions and presented three algorithms for building accurate decision trees that rely on reconstructed distributions (L. Breiman, J. H. Friedman, R. A. Olshen, and C. J. Stone, “Classification and Regression Trees,” Wadsworth, Belmont, 1984; and J. R. Quinlan, “Induction of Decision Trees,” Machine Learning, 1:81-106, 1986).

In D. Agrawal and C. C. Aggarwal, “On the Design and Quantification of Privacy Preserving Data Mining Algorithms,” In Proc. of the 20th ACM Symposium on Principles of Database Systems, pages 247-255, Santa Barbara, Calif., May 2001, the authors derived an Expectation Maximization (EM) algorithm for reconstructing distributions and proved that the EM algorithm converged to the maximum likelihood estimate of the original distribution based on the perturbed data. The EM algorithm was in fact identical to the Bayesian reconstruction procedure except for an approximation (partitioning values into intervals) that was made by the latter (R. Agrawal and R. Srikant, “Privacy Preserving Data Mining,” In Proc. of the ACM SIGMOD Conference on Management of Data, pages 439-450, Dallas, Tex., May 2000).

### SUMMARY OF THE INVENTION

The following discloses a method of mining association rules from the databases while maintaining privacy of individual transactions within the databases through randomization. The invention randomly drops true items from transactions within a database and randomly inserts false items into the transactions. The invention selects random items in the random transactions, and then randomly replaces some of the random items in random transactions with false items. The invention mines the database for association rules after the dropping and inserting processes by estimating nonrandomized support of an association rule in the original dataset based on the support for said association rule in said randomized dataset.

The dropping of the true items and the inserting of the false items is carried out to an extent such that the chance of finding a false itemset in a randomized transaction relative to the chance of finding a true itemset in said randomized transaction is above a predetermined threshold. The predetermined threshold provides that the chance of finding a false itemset in said randomized transaction is approximately equal to the chance of finding a true itemset in said randomized transaction.

The randomization includes per transaction randomizing, such that randomizing operators are applied to each transaction independently. The randomization is item-invariant such that a reordering of the transactions does not affect outcome probabilities. The randomization includes a cut and paste operation which is limited to two randomization parameters. The length of the transactions is limited by an upper limit.

The invention also includes a method which, prior to the randomizing and inserting, tests a portion of the transactions to adjust the inserting and dropping processes to make the chance of finding a false itemset approximately equal the chance of finding a true itemset in the database. The dropping and the inserting are performed independently on the transactions.

### BRIEF DESCRIPTION OF THE DRAWINGS

The foregoing and other objects, aspects and advantages will be better understood from the following detailed description of a preferred embodiment(s) of the invention with reference to the drawings, in which:

FIG. 1 is a chart illustrating lowest discoverable support for different breach levels;

FIG. 2 is a chart illustrating lowest discoverable support versus number of transactions;

FIG. 3 is a chart illustrating lowest discoverable support for different transaction sizes;

FIG. 4 is a chart illustrating number of transactions for each transaction size in the soccer and mailorder datasets;

FIG. 5 is a table for soccer illustrating actual parameters for cutoff and randomization levels for transaction size;

FIG. 6 is a table for mailorder illustrating actual parameters for cutoff and randomization levels for transaction size;

FIG. 7 is a table for mailorder illustrating results on real datasets;

FIG. 8 is a table for soccer illustrating results on real datasets;

FIG. 9 is a table for mailorder illustrating analysis of false drops;

FIG. 10 is a table for soccer illustrating analysis of false drops;

FIG. 11 is a table for mailorder illustrating analysis of false positives;

FIG. 12 is a table for soccer illustrating analysis of false positives;

FIG. 13 is a table for soccer illustrating actual privacy breaches; and

FIG. 14 is a table for mailorder illustrating actual privacy breaches.

### DETAILED DESCRIPTION OF PREFERRED EMBODIMENTS OF THE INVENTION

The present invention generally relates to privacy preserving data mining to build accurate data mining models over aggregated data while preserving privacy in individual data records. This invention introduces the problem of mining association rules over transactions where the transaction data has been sufficiently randomized to preserve privacy in individual transactions, and a framework for recovering the support that allows for a class of randomization operators. While it is feasible to recover association rules while preserving privacy for most transactions, the nature of association rules makes them intrinsically susceptible to privacy breaches, where privacy is not preserved for some small number of transactions. The straightforward “uniform” privacy operator is highly susceptible to such privacy breaches.

The invention presents a framework for mining association rules from transactions of categorical items where the data has been randomized to preserve privacy of individual transactions. While it is feasible to recover association rules and preserve privacy using a straightforward “uniform” randomization, the discovered rules can be exploited to find privacy breaches. Analyzing the nature of privacy breaches and proposing a class of randomization operators are more effective than uniform randomization in limiting the breaches. Deriving formulae for an unbiased support estimator and its variance, allows the recovery of itemset supports from randomized datasets, and shows how to incorporate these formulae into mining algorithms.

The invention continues into the use of randomization in developing privacy-preserving data mining techniques, and extended the line of inquiry along two dimensions. These dimensions are the categorical data instead of numerical data and association rule mining instead of classification. The invention focuses on the task of finding frequent itemsets in association rule mining using the following examples and definitions (R. Agrawal, T. Imielinski, and A. Swami, “Mining Association Rules Between Sets Of Items In Large Databases,” In Proc. of the ACM SIGMOD Conference on Management of Data, pages 207-216, Washington, D.C., May 1993”).

Definition 1. Suppose there is a set of I of n items: I={a₁, a₂, . . . , aₙ}. Let T be a sequence of N transactions T=(t₁, t₂, . . . , tₙ) where each transaction tᵢ is a subset of I. Given an itemset A⊂I, its support supp^{T} (A) is defined as

$${Supp}^{T} ( A ) := \frac{\# \{ t ∉ T \vert A ⊆ t \}}{N} . \qquad ( 1 )$$

An itemset A⊂I is called frequent in T is supp^{T} (A)≧τ, where τ is a user-defined parameter.

Consider the following setting. Suppose there is a server and many clients. Each client has a set of items (e.g., books or web pages or TV programs). The clients want the server to gather statistical information about associations among items, perhaps in order to provide recommendations to the clients. However, the clients do not want the server to know with certainty who has got which items. When a client sends its set of items to the server, it modifies the set according to some specific statistical information from the modified sets of items (transactions) and recovers from it the actual associations.

The following are some of the benefits produced by the invention. The following shows that a straightforward uniform of randomization leads to privacy breaches. The invention formally models and defines privacy breaches. The invention presents a class of randomization operators that can be tuned for different tradeoffs between discoverability and privacy breaches. Formulae are derived for the effect of randomization on support and the following shows how to recover the original support of an association from the randomized data. The experimental results that validate the algorithm are applied on real datasets and the following graphs show the relationship between discoverability, privacy, and data characteristics.

There has been extensive research in the area of statistical databases motivated by the desire to provide statistical information (sum, count, average, maximum, minimum, path, percentile, etc.) without compromising sensitive information about individuals (see surveys in N. R. Adam and J. C. Wortman, “Security-Control Methods for Statistical Databases, ACM Computing Surveys, 21(4):515-556, Dec. 1989 (hereinafter referred to as “Adam”) and A. Shoshani, “Statistical Databases: Characteristics, Problems and Some Solutions,” In VLDB, pages 208-213, Mexico City, Mexico, September 1982).

The following techniques can be broadly classified into query restriction and data perturbation. The query restriction family includes restricting the size of the query result, controlling the overlap amongst successive queries, keeping an audit trail of all answered queries and constantly checking for possible compromise, suppressing data cells of small size, and clustering entities into mutually exclusive atomic populations. The perturbation family includes swapping values between records, replacing the original database with a sample from the same distribution, adding noise to the values in the database, adding noise to the results of a query, and sampling the result of a query. There are negative results showing that the proposed techniques cannot satisfy the conflicting objectives of providing high quality statistics and at the same time prevent exact or partial disclosure of individual information (see Adam). The most relevant work from the statistical database literature is the work by Warner (S. Warner, “Randomized Response: A Survey Technique For Eliminating Evasive Answer Bias,” J. Am. Stat. Assoc., 60(309):63-69, March 1965) where he developed the “Randomized Response” method for survey results. The method deals with a single Boolean attribute (e.g., drug addiction). The value of the attribute is retained with probability p and flipped with probability 1−p. Warner then derived equations for estimating the true value of queries such as COUNT (Age=42 & Drug Addiction=Yes). Another related work is J. Vaidya and C. W. Clifton, “Privacy Preserving Association Rule Mining In Vertically Partitioned Data,” In Proc. of the 8th ACM SIGKDD Int'l Conference on Knowledge Discovery and Data Mining, Edmonton, Canada, July 2002, where they consider the problem of mining association rules over data that is vertically partitioned across two sources, i.e., for each transaction, some of the items are in one source, and the rest in the other source. They use multi-party computation techniques for scalar products to be able to compute the support of an itemset (when the two subsets that together form the itemset are in different sources), without either source revealing exactly which transactions support a subset of the itemset. In contrast, this invention focuses on preserving privacy when the data is horizontally partitioned, i.e., to preserve privacy for individual transactions, rather than between two data sources that each have a vertical slice.

Related, but not directly relevant to the invention, is the problem of inducing decision trees over horizontally partitioned training data originating from sources that do not trust each other. In V. Estivill-Castro and L. Brankovic, “Data Swapping: Balancing Privacy Against Precision In Mining for Logic Rules,” In M. Mohania and A. Tjoa, Editors, Data Warehousing and Knowledge, Discovery DaWaK-99, pages 389-398, Springer-Verlag Lecture Notes in Computer Science 1676, 1999, each source first builds a local decision tree over its true data, and then swaps values amongst records in a leaf node of the tree to generate randomized training data. Another approach, presented in Y. Lindell and B. Pinkas, “Privacy Preserving Data Mining, In CRYPTO, pages 36-54, 2000, does not use randomization, but makes use of cryptographic oblivious functions during tree construction to preserve privacy of two data sources.

A straightforward approach for randomizing transactions generalizes Warner's “Randomized Response” method described above. Before sending a transaction to the server, the client takes each item and with probability p replaces it with a new item not originally present in this transaction. This process is called uniform randomization.

Estimating true (nonrandomized) support of an itemset is nontrivial even for uniform randomization. Randomized support of, say, a 3-itemset depends not only on its true support, but also on the supports of its subsets. Indeed, it is much more likely that only one or two of the items are inserted by chance than all three. So, almost all “false” occurrences of the itemset are due to (and depend on) high subset supports. This requires estimating the supports of all subsets simultaneously. (The algorithm is similar to the algorithm presented below for select-a-size randomization, and the formulae from statements 1, 3 and 4 apply here as well.) For large values of p, most of the items in most randomized transactions will be “false” so reasonable privacy protection is obtained. Also, if there are enough clients and transactions, then frequent itemsets will still be “visible”, though less frequent than originally. For instance, after uniform randomization with p=80%, an itemset of 3 items that originally occurred in 1% of transactions will occur in about 1% (0.2)³=0.008% of transactions, which is about 80 transactions per each million. The opposite effect of “false” itemsets becoming more frequent is comparatively negligible if there are many possible items, for 10,000 items, the probability that, say, 10 randomly inserted items contain a given 3-itemset is less than 10⁻⁷%.

Unfortunately, this randomization has a problem. If 3-itemset escapes randomization in 80 per million transactions, and it is unlikely to occur even once because of randomization, then every time it is in a randomized transaction, its presence in the nonrandomized transaction is known. With even more certainty, at least one item from this itemset is “true” as mentioned, a chance insertion of only one or two of the items is much more likely than of all three. In this case, a privacy breach has occurred. Although privacy is preserved on average, personal information leaks through uniform randomization for some fraction of transactions, despite the high value of p. The rest of the disclosure is devoted to defining a framework for studying privacy breaches and developing techniques for finding frequent itemsets while avoiding breaches.

Another definition is labeled “Definition 2”. In Definition 2, let Ω, F, P be a probability space of elementary events over some set Ω and σ-algebra F. A randomization operator is a measurable function
R:Ω×{all possible T}→{all possible T}
that randomly transforms a sequence of N transactions into a (usually) different sequence of N transactions. Given a sequence of N transactions T, write T′=R(T), where T is constant and R(T) is a random variable. In “Definition 3,” suppose that a nonrandomized sequence T is drawn from some known distribution, and tᵢ∈T is the i-th transaction in T. A general privacy breach of level ρ with respect to a property P(tᵢ) occurs if:
∃T′:P[P(tᵢ)|R(T)=T]≧ρ.
A property Q(T′) causes a privacy breach of level ρ with respect to P(tᵢ) if:
P[P(tᵢ)|Q(R(T))]≧ρ.

When defining privacy breaches, think of the prior distribution of transactions as known, so that it makes sense to speak about a posterior probability of a property P(tᵢ) versus prior. In practice, however, the prior distribution is not known. In fact, there is no prior distribution, the transactions are not randomly generated. However, modeling transactions as being randomly generated from a prior distribution allows the process to cleanly define privacy breaches.

Consider a situation when, for some transaction tᵢ∈T, an itemset A⊂I and an item a∈A, the property “A⊂t′ᵢ∈T′” causes a privacy breach w.r.t. the property “A∈tᵢ.” In other words, the presence of A in a randomized transaction makes it likely that item a is present in the corresponding nonrandomized transaction. In “Definition 4,” an itemset A causes a privacy breach of level ρ if for some item a∈A and some i∈1 . . . N where P [a∈tᵢ|A⊂t′ᵢ]ρ.

The invention focuses on controlling the class of privacy breaches given by Definition 4. Thus, the invention ignores the effect of other information the server obtains from a randomized transaction, such as which items the randomized transaction does not contain, or the randomized transaction size. The invention does not attempt to control breaches that occur because the server knows some other information about items and clients besides the transactions. For example, the server may know some geographical or demographic data about the clients. Finally, in Definition 4, only the positive breaches are considered, (i.e., with high probability that an item was present in the original transaction). In some scenarios, being confident that an item was not present in the original transaction may also be considered a privacy breach.

The inventive breach control is based on the following premise: in addition to replacing some of the items, the invention inserts so many “false” items into a transaction, that one is as likely to see a “false” itemset as a “true” one. Thus, the following shows how the invention randomly drops true items from transactions within a database, and randomly inserts false items into the transactions. In such processing, the invention selects random items in the random transactions, and then randomly replaces some of the random items in random transactions with false items. After this, the invention mines the database for association rules by estimating nonrandomized support of an association rule in the original dataset based on the support for said association rule in said randomized dataset. The dropping of the true items and the inserting of the false items is carried out to an extent such that the chance of finding a false itemset in a randomized transaction relative to the chance of finding a true itemset in said randomized transaction is above a predetermined threshold. The predetermined threshold provides that the chance of finding a false itemset in said randomized transaction is approximately equal to the chance of finding a true itemset in said randomized transaction.

In “Definition 5”, randomization R is a per-transaction randomization, if for T=(t₁, t₂, . . . , t_{N}), we can represent R(T) as
R(t₁, t₂, . . . , t_{N})=(R(1, t₁),R(2,t₂), . . . ,R(N, t_{N})),
where R(i, t) are independent random variables whose distributions depend only on t (and not on i). t′ᵢ=R(i, tᵢ)=R(tᵢ).

In “Definition 6,” a randomization operator R is called item invariant if, for every transaction sequence T and for every permutation π: I→I of items, the distribution of π⁻¹R(πT) is the same as of R(T). Here πT means the application of π to all items in all transactions of T at once.

In “Definition 7,” a select-a-size randomization operator has the following parameters for each possible input transaction size. The default probability of an item (also called randomization level) ρₘ∈ (0, 1). The transaction subset size selection probabilities πₘ[0], πₘ[1], . . . , πₘ[m], are such that every πₘ[j]≧0 and πₘ[0]+πₘ[1]+. . . +πₘ[m]=1.

Given a sequence of transactions T=(t₁, t₂, . . . , t_{N}), the operator takes each transaction tᵢ independently and proceeds as follows to obtain transaction t′ᵢ (m=|tᵢ|). The operator selects an integer j at random from the set {0, 1, . . . m} so that P[j is selected]=πₘ[j]. It selects j items from tᵢ, uniformly at random (without replacement). These items, and no other items of tᵢ are placed into t′ᵢ. It considers each item a∉tᵢ in turn and tosses a coin with probability πₘ of “heads” and 1−πₘ of “tails”. All those items for which the coin faces “heads” are added to t′ᵢ.

Both uniform and select-a-size operators are per-transaction because they apply the same randomization algorithm to each transaction independently. They are also item-invariant since they do not use any item-specific information (if we rename or reorder the items, the outcome probabilities will not be affected).

In “Definition 8,” a cut-and-paste randomization operator is a special case of a select-a-size operator and shall be tested on datasets. Each possible input transaction size m, has two parameters: πₘ (0, 1), randomization level and an integer Kₘ>0, the cutoff. The operator takes each input transaction tᵢ independently and proceeds as follows to obtain transaction t′ᵢ, here m=|tᵢ|). The operator chooses an integer j uniformly at random between 0 and Kₘ; if j>m, it sets j=m. The operator then selects j items out of tᵢ uniformly at random without replacement and placed into t′ᵢ. Each other item, including the rest of tᵢ is placed into t′i with probability πₘ, independently.

For any m, a cut-and-paste operator has only two parameters, πₘ and Kₘ, to play with. Moreover, Kₘ is an integer, because it is easy to find optimal values for these parameters (Section 4.4), this operator is tested, leaving open the problem of optimizing the m parameters of the “unabridged” select-a-size. To see that cut-and-paste is a case of select-a-size, see the formulae for the πₘ[j]'s:

$${p}_{m} [ j ] \cdot {\sum }_{i = 0}^{min \{ K , j \}} {( \begin{matrix}m . i \\ j - i\end{matrix} ) }_{p} j - i ( 1 - p ) m - j . \cdot \{ \begin{matrix}1 - m / ( K + 1 ) \\ 1 / ( K + 1 )\end{matrix} if i = m and i < K otherwise$$

One example of a randomization operator that is not a per-transaction randomization, is the use of the knowledge of several transactions per each randomized transaction. In “Example 1,” the mixing randomization operator has one integer parameter K≧2 and one real-valued parameter π∈ (0,1). Given a sequence of transactions T=(t₁, t₂, . . . , t_{N}), the operator takes each transaction tᵢ independently and proceeds as follows to obtain transaction t′ᵢ. Other than tᵢ, the operator picks K−1 more transactions (with replacement) from T and union the K transactions as sets of items. Let tr be this union. Consider each item a∈tr in turn and toss a coin with probability ρ of “heads” and 1−ρ of “tails”. All those items for which the coin faces “tails” are removed from the transaction. The remaining items constitute the randomized transaction.

For the purpose of privacy-preserving data mining, focus is mostly on per-transaction randomizations, since they are the easiest and safest to implement. Indeed, a per-transaction randomization does not require the users, who submit randomized transactions to the server, to communicate with each other in anyway, or to exchange random bits. On the contrary, implementing mixing randomization, for example, requires the organization of an exchange of nonrandomized transactions between users, which opens an opportunity for cheating or eavesdropping.

With respect to the effect of randomization on support, Let T be a sequence of transactions of length N, and let A be some subset of items (that is, A⊂I). Suppose, randomizing T and getting T′=R(T). The support s′=supp^{T′} (A) of A for T′ is a random variable that depends on the outcome of randomization. Here is the determination of the distribution of s′, under the assumption of having a per-transaction and item-invariant randomization.

In “Definition 9,” the fraction of the transactions in T that have intersection with A of size l among all transactions in T is called partial support of A for intersection size l:

$${supp}_{l}^{T} ( A ) := \frac{\# \{ t ∉ T \vert \# ( A ⋂ t ) = l \}}{N} . \qquad ( 2 )$$

It is easy to see that supp^{T} (A)=suppₖ^{T} (A) for k=|A| and that

$${\sum }_{l = 0}^{k} {supp}_{l}^{T} ( A ) = 1$$

since those transactions in T that do not intersect A at all are covered in supp₀^{T} (A).

In “Definition 10,” suppose that the randomization operator is both per-transaction and item-invariant. Consider a transaction t of size m and an itemset A⊂I of size k after randomization, transaction t becomes t′.
Pₖ^{m}[l→l′]=p[l→l′]:=P[#(t′∩A)=l′|#(t∩A)=l]. (3)
Here both l and l′ must be integers in {0, 1, . . . ,k}.

The value of pₖ^{m}[l→l′]is well-defined and does not depend on any other information about t and A, or other transactions in T and T′ besides t and t′. Indeed, because of per-transaction randomization, the distribution of t′ depends neither on other transactions in T besides t, nor on their randomized outcomes. If there were other tₗ and B with the same (m, k, l,), but a different probability (3) for the same l′, could be considered a permutation π of I such that πt=ti and πA=B. The application of π or of π⁻¹ would preserve intersection sizes l and l′. By item-invariance:
P[#(t′∩A)=l′]=P[#(π]⁻¹R(πt)∩A)=l′],
but by the choice of π there is also

$$P [ \# {π}^{- 1} R ( π t ) ⋂ A ) = {l}^{′} ] = P [ \# ( {π}^{- 1} R ( {t}_{i} ) ⋂ {π}^{- 1} B ) = {l}^{′} ] = P [ \# ( {t}_{1} ⋂ B ) = {l}^{′} ] \neq P [ \# ( {t}^{′} ⋂ A ) = {l}^{′} ] ,$$

“Statement 1”, supposes that the randomization operator is both per-transaction and item-invariant and that all the N transactions in T have the same size m. Then, for a given subset A⊂I, |A|=k, the random vector
N·(s′₀, s′₁, . . . , s′ₖ, where s′ₗ:=suppl^{T′}(A) (4)
is a sum of k+1 independent random vectors, each having a multinomial distribution. Its expected value is given by
E(s′₀, s′₁, . . . , s′ₖ)^{T}=P·(s₀, s₁, . . . , sₖ)^{T} (5)
where P is the (k+1)×(k+1) matrix with elements P_{l′l}=p[l→l′], and the covariance matrix is given by

$${Cov ( {s}_{0}^{′} , {s}_{1}^{′} , … , {s}_{k}^{′} )}^{T} = \frac{1}{N} \cdot {\sum }_{l = 0}^{k} {s}_{l} D [ l ] \qquad ( 6 )$$

where each D[l] is a (k+1)×(k+1) matrix with elements
D[l]ᵢⱼ=p[l→i]·δᵢ₌ⱼ−p[l→i]·p[l→j]. (7)
Here sₗ denotes suppₗ^{T} (A), and the T over vectors denotes the transpose operation δᵢ₌ⱼ is one and if i=j and zero otherwise.

In Statement 1 it is assumed that all transactions in T have the same size. If this is not so, considering each transaction size separately is applicable and then use per-transaction independence. In “Statement 2,” for a select-a-size randomization with randomization level ρ and size selection probabilities {pₘ[j]} there is:

$${p}_{k}^{m} [ l \to {l}^{′} = {\sum }_{j = 0}^{m} {p}_{m} [ j ] \cdot {\sum }_{q = max \{ 0 , j + l - m , l + {l}^{′} - k \}}^{min \{ j , l , {l}^{′} \}} \frac{( \begin{matrix}l \\ q\end{matrix} ) ( \begin{matrix}m - l \\ j - q\end{matrix} )}{( \begin{matrix}m \\ j\end{matrix} )} ( \begin{matrix}k - l \\ {l}^{′} - q\end{matrix} ) {{p}^{{l}^{′} - q} ( 1 - p )}^{k - l - {l}^{′} + q} . \qquad ( 8 )$$

As shown above, the invention randomizes transactions by dropping random items (e.g., true items) from the random transactions, and then randomly replacing some (or more) of the random items in random transactions with false items. The invention mines the database for association rules after the dropping and inserting processes by estimating nonrandomized support of an association rule in the original dataset based on the support for said association rule in said randomized dataset. To perform such estimation, assuming that all transactions in T have the same size m, and denoting
ₛ^{→}:=(s₀,s₁, . . . sₖ)^{T}, ₛ^{→′}:=(s₀,s₁,...,sₖ)^{T};
then,
Eₛ^{→′}=P·ₛ^{→}. (9)
Denote Q=P⁻¹ (assuming that it exists) and multiply both sides of (9) by Q:
ₛ^{→}=Q·Eₛ^{→′}=EQ·ₛ^{→′}.

Thus, the invention has obtained an unbiased estimator for the original partial supports given by randomized partial supports:
ₛ^{→} ₑₛₜ:Q·ₛ^{→′} (10)
Computing the covariance matrix of ₛ^{→}est is as follows by using (6):

$${Cov}_{s est}^{\to } = Cov ( Q {\cdot }_{s}^{{\to }^{′}} ) = Q ( {Cov}_{s}^{{\to }^{′}} ) {Q}^{T} = \frac{1}{N} {\cdot }_{l .0}^{k} {s}_{l} QD [ l ] {Q}^{T} . \qquad ( 11 )$$

By estimating this covariance matrix by looking only at randomized data, ₛ^{→}est instead of ₛ^{→}in (11);

$${( {Cov}_{s est}^{\to } )}_{est} = \frac{1}{N} \cdot {\sum }_{l = 0}^{k} {{(}_{s est}^{\to } )}_{l} QD [ l ] {Q}^{T} .$$

This estimator is also unbiased:

$${E ( {Cov}_{s est}^{\to } )}_{est} = \frac{1}{N} \cdot {\sum }_{l = 0}^{k} {( {E}_{s est}^{\to } )}_{l} QD [ l ] {Q}^{T} = {Cov}_{s est}^{\to } .$$

In practice, only the k-th coordinate of ₛ^{→}, that is, the support s=supp^{T} (A) of the itemset A in T. By denoting by ₛ^{˜}the k-th coordinate of ₛ^{→} ₑₛₜ, and use ₛ^{˜}to estimate s, computes a simple formulae for ₛ^{˜}, its variance and the unbiased estimator of its variance.
q[l→l′]:=Q_{ll′}.

”Statement 3” is a follows:

$$\begin{matrix}\begin{matrix}\tilde{s} = {\sum }_{{l}^{′} = 0}^{k} {s}_{{l}^{′}}^{′} \cdot q [ k ← {l}^{′} ] ; \\ {Var}_{\tilde{s}} = \frac{1}{N} {\sum }_{l = 0}^{k} {s}_{l} ( {\sum }_{{l}^{′} = 0}^{k} p [ l \to {l}^{′} ] {q [ k ← {l}^{′} ]}^{2} - {δ}_{l - k} ) ;\end{matrix} \\ {( {Var}_{\tilde{s}} )}_{est} = \frac{1}{N} {\sum }_{{l}^{′} = 0}^{k} {s}_{{l}^{′}}^{′} ( {q [ k ← {l}^{′} ]}^{2} - q [ k ← {l}^{′} ] ) .\end{matrix}$$

This subsection is concluded by giving a linear coordinate transformation in which the matrix P from Statement 1 becomes triangular. (This transformation for privacy is used for breach analysis below). The coordinates after the transformation have a combinatorial meaning, as given in the following definition.

In “Definition 11,” suppose there is a transaction sequence T and an itemset ⊂. Given an integer l between 0 and k=|A|, consider all subsets C⊂ A of size l. The sum of supports of all these subsets is called the cumulative support for A of order l and is denoted as follows:

$$\begin{matrix}{\sum }_{l}^{} = {\sum }_{l}^{} ( A , T ) := {\sum }_{C ⊆ A , \vert C \vert = l}^{} {supp}^{T} ( C ) , \\ \vec{\sum } := {( {\sum }_{0}^{} , {\sum }_{1}^{} , … , {\sum }_{k}^{} )}^{T}\end{matrix} \qquad ( 12 )$$

In “Statement 4,” the vector

$$\vec{\sum }$$

of cumulative supports is a linear transformation of the vector ₛ^{→} of partial supports, namely:

$${\sum }_{l}^{} = {\sum }_{j = l}^{k} ( \begin{matrix}j \\ l\end{matrix} ) {s}_{j} and {s}_{l} = {\sum }_{j = l}^{k} {( - 1 )}^{j - l} ( \begin{matrix}j \\ l\end{matrix} ) {\sum }_{j}^{} ; \qquad ( 13 )$$

in the

$$\vec{\sum } and \vec{\sum }$$

space instead of ₛ^{→} and ₛ^{43 ′} matrix P is the lower triangle.

When performing privacy breach analysis, the invention determines how privacy depends on randomization. The invention shall use Definition 4 and assume a per-transaction and item-invariant randomization. Consider some itemset A⊂I and some item a∈A; fix a transaction size m. The invention shall assume that m is known to the server, so that the invention does not have to combine probabilities for different nonrandomized sizes. Assume also that a partial support sₗ=suppₗ^{T} (A) approximates the corresponding prior probability P[#(t∩A)=l]. Suppose the invention know the following prior probabilities:
sₗ⁺:=P[#(t∩A=l,a ∈t],
sₗ⁻:=P[#(t∩A=l,a ∉t].
Notice that sₗ=sₗ⁺+sₗ⁻ simply because

$$\# ( t ⋂ A = l - [ \begin{matrix}a ∈ t \& \# ( t ⋂ A ) = l , \\ a ∉ t \&\& \# ( t ⋂ A ) = l\end{matrix}$$

or

Let us use these priors and compute the posterior probability of a∈t given A

$$⊆ {t}^{′} : P [ a ∈ t \vert A ⊆ {t}^{′} ] = \frac{P [ a ∈ t , A ⊆ {t}^{′} ]}{P [ A ⊆ {t}^{′} ]} = {\sum }_{l = 1}^{k} P [ \# ( t ⋂ A ) = l , a ∈ t , A ⊆ {t}^{′} ] / {\sum }_{l = 0}^{k} {s}_{l} \cdot p [ 1 \to k ] {\sum }_{l = 1}^{k} P [ \# ( t ⋂ A ) = l , a ∈ t ] \cdot p [ l \to k ] / {\sum }_{l = 0}^{k} {s}_{l} \cdot p [ 1 \to k ] = {\sum }_{l = 1}^{k} {s}_{-}^{+} \cdot p [ l \to k ] / {\sum }_{l = 0}^{k} {s}_{l} \cdot p [ l \to k ] .$$

Thus, in order to prevent privacy breaches of level 50% as defined in Definition 4, the invention need to ensure that always

$${\sum }_{l = 1}^{k} {s}_{-}^{+} \cdot p [ l \to k ] < 0.5 \cdot {\sum }_{l = 0}^{k} {s}_{l} \cdot p [ l \to k ] . \qquad ( 14 )$$

The problem is that the invention has to randomize the data before the invention know any supports. Also, the invention may not have the luxury of setting “oversafe” randomization parameters because then the invention may not have enough data to perform a reasonably accurate support recovery. One way to achieve a compromise is to estimate the maximum possible support sₘₐₓ (k, m) of a k-itemset in the transactions of given size m, for different k and m. Given the maximum supports, find values for sₗ and s₋⁺ that are most likely to cause a privacy breach. Make randomization just strong enough to prevent such a privacy breach.

Since s₀⁺=0, the most privacy-challenging situations occur when s₀ is small, that is, when our itemset A and its subsets are frequent. In the experiments, the invention considers a privacy-challenging k-itemset A such that, for every l>0, all its subsets of size l have the maximum possible support sₘₐₓ (l, m). The partial supports for such a test-itemset are computed from the cumulative supports

$${\sum }_{l}$$

using Statement 4. By it and by (12), the invention has (l>0)

$${S}_{l} = {\sum }_{j = l}^{k} {( - 1 )}^{j - 1 ( \begin{matrix}j \\ l\end{matrix} )} {\sum }_{j}^{} , {\sum }_{j}^{} = ( \begin{matrix}k \\ j\end{matrix} ) {s}_{max} ( j , m ) \qquad ( 15 )$$

since there are (ⱼ^{k})j-subsets in A. The values of s₋⁺ follow if the invention note that all l-subsets of A, with a and without, appear equally frequently as t∩A:

$${s}_{-}^{+} := P [ \# ( t ⋂ A ) = l , a ∈ t ] = P [ a ∈ t \vert \# ( t ⋂ A ) = l ] \cdot {s}_{l} = l / k \cdot {s}_{l} . \qquad ( 16 )$$

While one can construct cases that are even more privacy-challenging (for example, if a∈A occurs in a transaction every time any nonempty subset of A does), the invention finds the above model (15) and (16) to be sufficiently pessimistic on our datasets. The invention can now use these formulae to obtain cut-and-paste randomization parameters ρₘ and Kₘ as follows. Given m, consider all cutoffs from Kₘ=3 to some Kₘₐₓ (usually this Kₘₐₓ equals the maximum transaction size) and determine the smallest randomization levels pm(Kₘ) that satisfy (14). Then select (Kₘ, πₘ) that gives the best discoverability (by computing the lowest discoverable supports).

The invention shows how to discover associations (itemsets with high true support) given a set of randomized transactions. Although the invention use the A priori algorithm to make the ideas concrete, the modifications directly apply to any algorithm that uses A priori candidate generation, i.e., to most current association discovery algorithms (R. Agrawal et al., “Fast Discovery of Association Rules,” In U. M. Fayyad, G. Piatetsky-Shapiro, P. Smyth, and R. Uthurusamy, Editors, “Advances in Knowledge Discovery and Data Mining,” Chapter 12, pages 307-328. AAAI/MIT Press, 1996). The main class of algorithms where this would not apply are those that find only maximal frequent itemsets, e.g., R. Bayardo, “Efficiently Mining Long Patterns from Databases,” In Proc. of the ACM SIGMOD Conference on Management of Data, Seattle, Wash., 1998. However, randomization precludes finding very long item-sets, so this is a moot point. The key lattice property of supports used A priori is that, for any two itemsets A⊂B. the true support of A is equal to or larger than the true support of B. A simplified version of A priori, given a (nonrandomized) transactions file and a minimum support sₘᵢₙ, works as follows:

1. Let k=1, let “candidate sets” be all single items. Repeat the following until no candidate sets are left: (a) Read the data file and compute the supports of all candidate sets; (b) Discard all candidate sets whose support is below sₘᵢₙ; (c) Save the remaining candidate sets for output; (d) Form all possible (k+1)-itemsets such that all their k-subsets are among the remaining candidates (let these itemsets be the new candidate sets); and (e) Let k=k+1.

2. Output all the saved itemsets. It is (conceptually) straightforward to modify this algorithm so that now it reads the randomized dataset, computes partial supports of all candidate sets (for all nonrandomized transaction sizes) and recovers their predicted supports and sigmas using the formulae from Statement 3.

However, for the predicted supports the lattice property is no longer true. It is quite likely that for an itemset that is slightly above minimum support and whose predicted support is also above minimum support, one of its subsets will have predicted support below minimum support. So if all candidates below minimum support are discarded for the purpose of candidate generation, many (perhaps even the majority) of the longer frequent itemsets will be missed. Hence, for candidate generation, the invention discards only those candidates whose predicted support is “significantly” smaller than sₘᵢₙ, where significance is measured by means of predicted sigmas.

Here is the modified version of A priori:

1. Let k=1, let “candidate sets” be all single-item sets. Repeat the following until k is too large for support recovery (or until no candidate sets are left): (a) Read the randomized datafile and compute the partial supports of all candidate sets, separately for each nonrandomized transaction size (in the invention's experiments, the nonrandomized transaction size is always known and included as a field into every randomized transaction); (b) Recover the predicted supports and sigmas for the candidate sets; (c) Discard every candidate set whose support is below its candidate limit; (d) Save for output only those candidate sets whose predicted support is at least sₘᵢₙ; (e) Form all possible (k+1)-itemsets such that all their k-subsets are among the remaining candidates (let these itemsets be the new candidate sets); and (f) Let k=k+1.

2. Output all the saved itemsets. The invention first tried sₘᵢₙ−σ and sₘᵢₙ−2σ as the candidate limit, and found that the former does a little better than the latter. It prunes more itemsets and therefore, makes the algorithm work faster, and, when it discards a subset of an itemset with high predicted support, it usually turns out that the true support of this itemset is not as high.

Before discussing the experiments with datasets, it is first shown how the ability to recover supports depends on the permitted breach level, as well as other data characteristics. The following then describes the real-life datasets and present results on these datasets.

The invention defines the “lowest discoverable support” as the support at which the predicted support of an itemset is four sigmas away from zero, i.e., the invention can clearly distinguish the support of this itemset from zero. In practice, the invention may achieve reasonably good results even if the minimum support level is slightly lower than four sigma (as was the case for 3-itemsets in the randomized “soccer,” see example below). However, the lowest discoverable support is a nice way to illustrate the interaction between discoverability, privacy breach levels, and data characteristics.

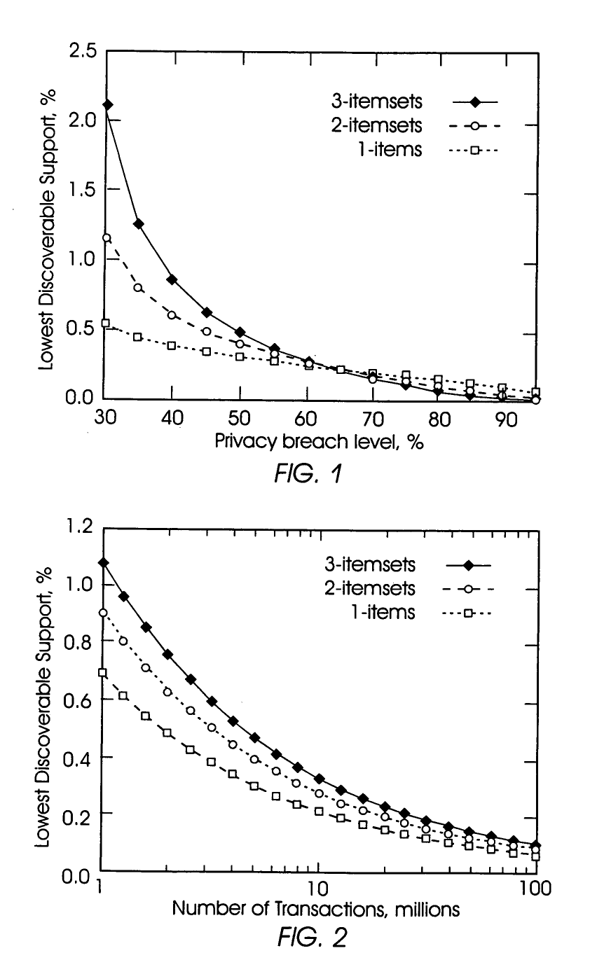

FIG. 1 shows how the lowest discoverable support changes with the privacy breach level. For higher privacy breach levels such as 95% (which could be considered a “plausible denial” breach level), the invention discovers 3-itemsets at very low supports. For more conservative privacy breach levels such as 50%, the lowest discoverable support is significantly higher. It is interesting to note that at higher breach levels (i.e. weaker randomization) it gets harder to discover 1-itemset supports than 3-itemset supports. This happens because the variance of a 3-itemset predictor depends highly nonlinearly on the amount of false items added while randomizing. When the invention adds fewer false items at higher breach levels, the invention generates so much fewer false 3-itemset positives than false 1-itemset positives, that 3-itemsets get an advantage over single items.

FIG. 2 shows that the lowest discoverable support is roughly inversely proportional to the square root of the number of transactions. Indeed, the lowest discoverable support is defined to be proportional to the standard deviation (square root of the variance) of this support's prediction. If all the partial supports are fixed, the prediction's variance is inversely proportional to the number N of transactions according to Statement 3. In the invention, the partial supports depend on N (because the lowest discoverable support does), i.e., they are not fixed; however, this does not appear to affect the variance very significantly (but justifies the word “roughly”).

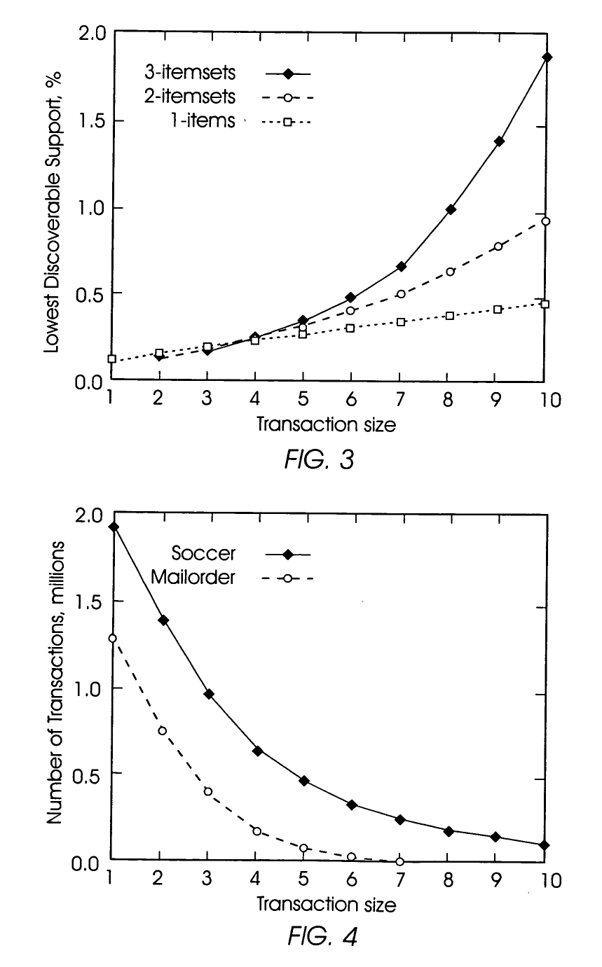

Finally, FIG. 3 shows that transaction size has a significant influence on support discoverability. In fact, for transactions of size 10 and longer, it is typically not possible to make them both breach-safe and simultaneously get useful information for mining transactions. Intuitively, a long transaction contains too much personal information to hide, because it may contain long frequent itemsets whose appearance in the randomized transaction could result in a privacy breach. The invention has to insert a lot of false items and cutoff many true ones to ensure that such a long itemset in the randomized transaction is about as likely to be a false positive as to be a true positive. Such a strong randomization causes an exceedingly high variance in the support predictor for 2- and especially 3-itemsets, since it drives down their probability to “tunnel” through while raising high the probability of a false positive. In both the invention's datasets the invention discards long transactions.

The invention experiments with two “real-life” datasets. The soccer dataset is generated from the clickstream log of the 1998 World Cup Web site, which is publicly available at ftp://researchsmp2.cc.vt.edu/pub/worldcup/4. The invention scanned the log and produced a transaction file, where each transaction is a session of access to the site by a client. Each item in the transaction is a web request. Not all web requests were turned into items; to become an item, the request must satisfy the following: 1. Client's request method is GET; 2. Request status is OK; 3. File type is HTML.

A session starts with a request that satisfies the above properties, and ends when the last click from this ClientID timeouts. The timeout is set as 30 minutes. All requests in a session have the same ClientID. The soccer transaction file was then processed further: the invention deleted from all transactions the items corresponding to the French and English front page frames, and then the invention deleted all empty transactions and all transactions of item size above 10. The resulting soccer dataset showed that the number of transactions for each transaction size in the soccer and mailorder datasets consists of 6; 525; 879 transactions, distributed as shown in FIG. 4. The mailorder dataset shown in FIG. 4 is the same as that used in R. Agrawal and R. Srikant, “Fast Algorithms for Mining Association Rules”, Research Report RJ 9839, IBM Almaden Research Center, San Jose, Calif., June 1994. The original mailorder dataset consisted of around 2.9 million transactions, 15,836 items, and around 2.62 items per transaction. Each transaction was the set of items purchased in a single mail order. However, very few itemsets had reasonably high supports. For instance, there were only two 2-itemets with support >0.2%, only five 3-itemsets with support >0.05%. Hence, in this example, it was decided to substitute all items by their parents in the taxonomy, which reduced the number of items from 15836 to 96. It seems that, in general, moving items up the taxonomy is a natural thing to do for preserving privacy without losing aggregate information. Also, all transactions of item size ≧8 (which was less than 1% of all transactions) were discarded to obtain a dataset containing 2; 859; 314 transactions (FIG. 4).

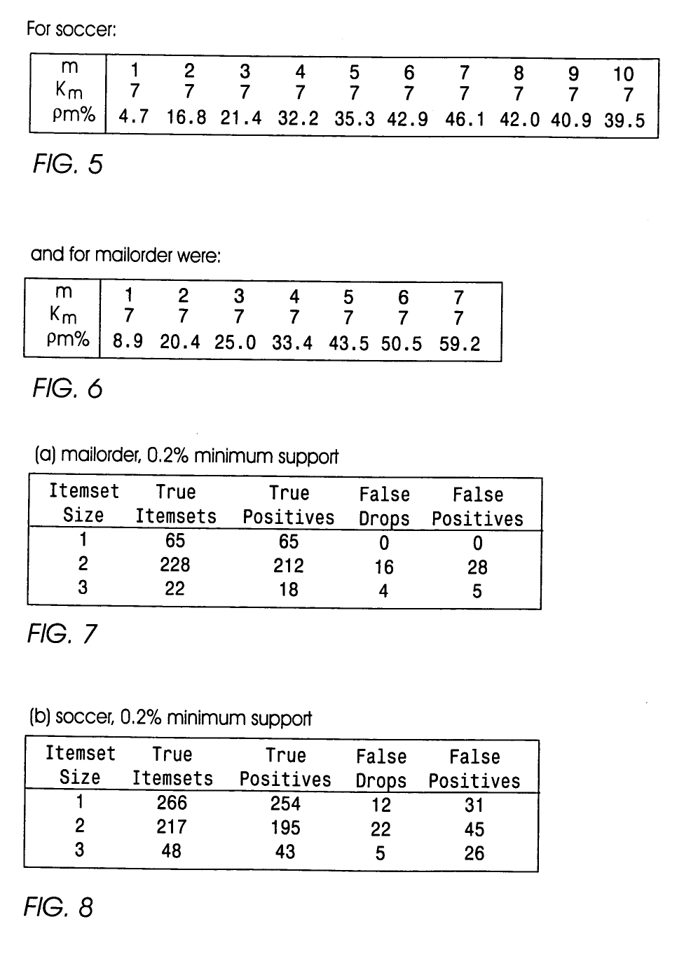

The following reports the results of applying the inventive randomization to both datasets at a minimum support that is close to the lowest discoverable support, in order to show the resilience of the invention even at these very low support levels. A conservative breach level of 50% was targeted, so that, given a randomized transaction, for any item in the transaction it is at least as likely that someone did not buy that item (or access a web page) as that they did buy that item. The invention used cut-and-paste randomization (see Definition 8) that has only two parameters, randomization level and cutoff, per each transaction size. A cutoff of 7 for this experiment was chosen as a good compromise between privacy and discoverability. Given the values of maximum supports, the invention then used the methodology the privacy breach analysis above (equations 14-16) to find the lowest randomization level such that the breach probability (for each itemset size) is still below the desired breach level. The actual parameters (Kₘ is the cutoff and ρₘ is the randomization level for transaction size m) for soccer are shown in FIG. 5, and FIG. 6 shows the same for mail order.

The tables in FIGS. 7 and 8 show what happens if the invention mine itemsets from both randomized and nonrandomized files and then compare the results. The invention can see that, even for a low minimum support of 0:2%, most of the itemsets are mined correctly from the randomized soccer and mailorder files. There are comparatively few false positives (itemsets wrongly included into the output) and even fewer false drops (itemsets wrongly omitted). The predicted sigma for 3-itemsets ranges in 0.066-0:07% for soccer and in 0.047-0.048% for mailorder; for 2- and 1-itemsets sigmas are even less.

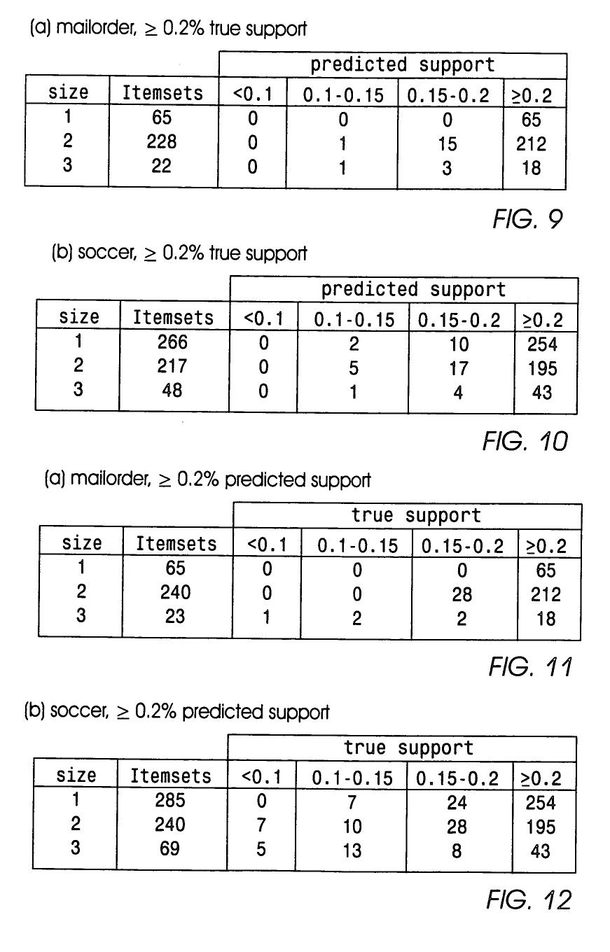

One might be concerned about the true supports of the false positives. Since there are many more low-supported itemsets than there are highly supported itemsets, most of the false positives could be outliers, that is, have true support near zero. However, with the invention, it turns out that most of the false positives are not so far off. The tables in FIGS. 9-12 show that usually the true supports of false positives, as well as the predicted supports of false drops, are closer to 0.2% than to zero. This demonstrates the promise of the invention randomization as a practical privacy-preserving approach.

The invention evaluates privacy breaches, i.e., the conditional probabilities from Definition 4, as follows. The invention counts the occurrences of an itemset in a randomized transaction and its sub-items in the corresponding nonrandomized transaction. For example, assume an itemset {a, b, c} occurs 100 times in the randomized data among transactions of length 5. Out of these 100 occurrences, 60 of the corresponding original transactions had the item b. The invention thus provides that this itemset caused a 60% privacy breach for transactions of length 5, since for these 100 randomized transactions, the invention estimates with 60% confidence that the item b was present in the original transaction.

Out of all sub-items of an itemset, the invention chooses the item that causes the worst privacy breach. Then, for each combination of transaction size and itemset size, the invention computes over all frequent itemsets the worst and the average value of this breach level. If there are no frequent itemsets for some combination, we pick the itemsets with the highest support. Finally, the invention picks the itemset size that gave the worst value for each of these two values.

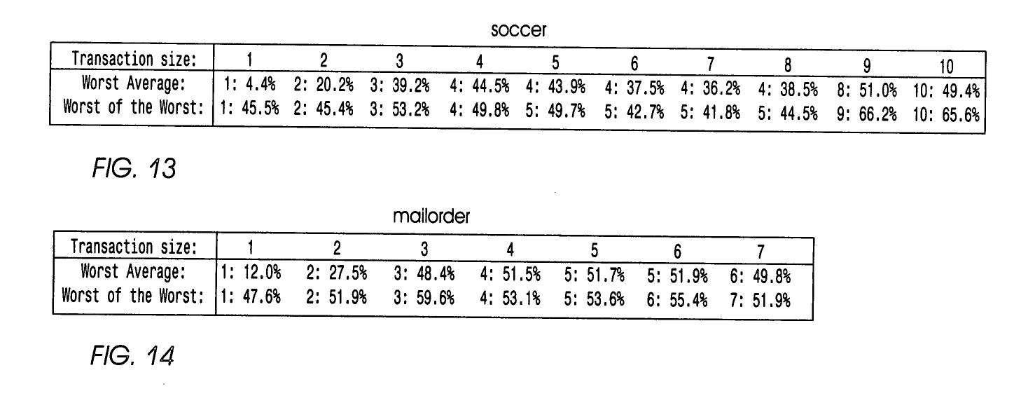

The tables in FIGS. 13 and 14 show the results of the above analysis. To the left of the semicolon is the itemset size that was the worst. For instance, for all transactions of length 5 for soccer, the worst average breach was with 4-itemsets (43.9% breach), and the worst breach was with a 5-itemset (49.7% breach). Thus, apart from fluctuations, the 50% level is observed everywhere except of a little “slip” for 9- and 10-item transactions of soccer. The “slip” resulted from the decision to use the corresponding maximal support information only for itemset sizes up to 7 (while computing randomization parameters). While this slip could be easily corrected, it is more instructive to leave it in. However, since such long associations cannot be discovered, in practice, the invention will not produce privacy breaches above 50%.

Despite choosing a conservative privacy breach level of 50%, and further choosing a minimum support around the lowest discoverable support, the invention was able to successfully find most of the frequent itemsets, with relatively small numbers of false drops and false positives.

The invention presents many contributions toward mining association rules while preserving privacy. First, the invention points out the problem of privacy breaches, presents their formal definitions and proposes a natural solution. Second, the invention gives a sound mathematical treatment for a class of randomization algorithms, derives formulae for support and variance prediction, and showed how to incorporate these formulae into mining algorithms. Finally, the invention presents experimental results that validated the algorithm in practice by applying it to two real datasets from different domains. Proofs of Statements 1-4 are shown in the attached appendix.

While the invention has been described in terms of preferred embodiments, those skilled in the art will recognize that the invention can be practiced with modification within the spirit and scope of the appended claims.

1. A method of mining association rules from datasets while maintaining privacy of individual transactions within said datasets through randomization, said method comprising:
randomly dropping true items from each transaction;
randomly inserting false items into each transaction; and
estimating the nonrandomized support of an association rule in the original dataset given its support in the randomized dataset.

2. The method in claim 1, wherein said randomization comprises per transaction randomizing, such that randomizing operators are applied to each transaction independently.

3. The method in claim 1, wherein said randomization is item-invariant such that a reordering of said transactions does not affect outcome probabilities.

4. The method in claim 1, wherein said dropping of said true items and said inserting of said false items are carried out to an extent such that the chance of finding a false itemset in a randomized transaction relative to the chance of finding a true itemset in said randomized transaction is above a predetermined threshold.

5. The method in claim 4, wherein said predetermined threshold provides that the chance of finding a false itemset in said randomized transaction is approximately equal to the chance of finding a true itemset in said randomized transaction.

6. The method in claim 1, wherein said dropping of said true items and said inserting of said false items are performed independently on said transactions prior to the transactions being collected in the database.

7. A method of mining association rules from databases while maintaining privacy of individual transactions within said databases through randomization, said method comprising:
randomly dropping true items from each transaction;
randomly inserting false items into each transaction; and
mining said database for association rules after said dropping and inserting processes by estimating the nonrandomized support of an association rule in the original dataset given its support in the randomized dataset.

8. The method in claim 7, wherein said randomization comprises per transaction randomizing, such that randomizing operators are applied to each transaction independently.

9. The method in claim 7, wherein said randomization is item-invariant such that a reordering of said transactions does not affect outcome probabilities.

10. The method in claim 7, wherein said dropping of said true items and said inserting of said false items are carried out to an extent such that the chance of finding a false itemset in a randomized transaction relative to the chance of finding a true itemset in said randomized transaction is above a predetermined threshold.

11. The method in claim 10, wherein said predetermined threshold provides that the chance of finding a false itemset in said randomized transaction is approximately equal to the chance of finding a true itemset in said randomized transaction.

12. The method in claim 7, wherein said dropping and said inserting are performed independently on said transactions prior to the transactions being collected in the database.

13. A method of mining association rules from datasets while maintaining privacy of individual transactions within said datasets through randomization, said method comprising:
creating randomized transactions from an original dataset by:
randomly dropping true items from each transaction in said original dataset, and
randomly inserting false items into each said transaction;
creating a randomized dataset by collecting said randomized transactions; and
mining said database for association rules after said dropping and inserting processes by estimating nonrandomized support of an association rule in the original dataset based on the support for said association rule in said randomized dataset.

14. The method in claim 13, wherein said process of creating randomized transactions comprises per transaction randomizing, such that randomizing operators are applied to each transaction independently.

15. The method in claim 13, wherein said process of creating randomized transactions is item-invariant such that a reordering of said transactions does not affect outcome probabilities.

16. The method in claim 13, wherein said dropping of said true items and said inserting of said false items are carried out to an extent such that the chance of finding a false itemset in a randomized transaction relative to the chance of finding a true itemset in said randomized transaction is above a predetermined threshold.

17. The method in claim 16, wherein said predetermined threshold provides that the chance of finding a false itemset in said randomized transaction is approximately equal to the chance of finding a true itemset in said randomized transaction.

18. The method in claim 13, wherein said process of creating randomized transactions is performed independently on said transactions prior to the transactions being collected in said randomized database.

19. A program storage device readable by computer, tangibly embodying a program of instructions executable by the computer to perform a method of mining association rules from databases while maintaining privacy of individual transactions within said databases through randomization, said method comprising:
randomly dropping true items from each transaction;
randomly inserting false items into each transaction; and
mining said database for association rules after said dropping and inserting processes by estimating the nonrandomized support of an association rule in the original dataset given its support in the randomized dataset.

20. The program storage device in claim 19, wherein said randomization comprises per transaction randomizing, such that randomizing operators are applied to each transaction independently.

21. The program storage device in claim 19, wherein said randomization is item-invariant such that a reordering of said transactions does not affect outcome probabilities.

22. The program storage device in claim 19, wherein said dropping of said true items and said inserting of said false items are carried out to an extent such that the chance of finding a false itemset in a randomized transaction relative to the chance of finding a true itemset in said randomized transaction is above a predetermined threshold.

23. The program storage device in claim 22, wherein said predetermined threshold provides that the chance of finding a false itemset in said randomized transaction is approximately equal to the chance of finding a true itemset in said randomized transaction.

24. The program storage device in claim 19, wherein said dropping and said inserting are performed independently on said transactions prior to the transactions being collected in the database.
